(19) United States
(12) Patent Application Publication
(10) Pub. No.: US 2017/0030741 A1
(43) Pub. Date: Feb. 2, 2017

(54) MICRO-ELECTRO-MECHANICAL SYSTEM DEVICE WITH ELECTRICAL COMPENSATION AND READOUT CIRCUIT THEREOF

(71) Applicant: Richtek Technology Corporation, Zhubei City (TW)

(72) Inventors: Chiung-Wen Lin, Changhua (TW); Chiung-C. Lo, Zhunan Township (TW); Chia-Yu Wu, Kaohsiung (TW)

(21) Appl. No.: 15/057,912

(22) Filed: Mar. 1, 2016

(30) Foreign Application Priority Data
Jul. 31, 2015 (CN) 201510464597.X

(51) Int. Cl. G01D 5/241; G01D 18/00

(52) U.S. Cl. CPC G01D 5/2417; G01D 18/00

(57) ABSTRACT

A MEMS device includes: a fixed structure, a movable structure, and a compensation circuit. The fixed structure includes a fixed electrode and a fixed compensation electrode. The movable structure includes a movable electrode and a movable compensation electrode. The movable electrode and the fixed electrode form a sensing capacitor, and the movable compensation electrode and the fixed compensation electrode form a compensation capacitor. The compensation circuit compensates a sensing signal generated by the sensing capacitor with a compensation signal generated by the compensation capacitor. The sensing capacitor and the compensation capacitor do not form a differential capacitor pair. A proportion of the sensing area of the compensation capacitor to the sensing area of the sensing capacitor is lower than 1.

### CROSS REFERENCE

The present invention claims priority to CN 201510464597.X, filed on Jul. 31, 2015.

### BACKGROUND OF THE INVENTION

Field of Invention

The present invention relates to a micro-electro-mechanical system (MEMS) device with electrical compensation, in particular a MEMS device wherein a gain of a compensation capacitor is adjustable to thereby increase the sensing accuracy of the MEMS device.

Description of Related Art

To increase the sensing accuracy, FIG. 1 shows a MEMS device 10 according to U.S. Pat. No. 5,487,305, which includes a movable structure 11 and four supporting linkages 12 connected to the movable structure 11. The supporting linkages 12 are connected to the movable structure 11 to ensure better sensing accuracy. The supporting linkages 12 restrict the movement of the movable structure 11, and the sensing range is accordingly limited. For reference, U.S. Pat. No. 8,434,364, discloses a structure including multiple supporting linkages, which is similar to the structure of FIG. 1 and has a similar limitation.

FIG. 2 shows another prior art MEMS device 20 according to U.S. Pat. No. 4,736,629, which includes two sensing capacitors 21 and 22 located at opposite sides with respect to an anchor 23. The sensing capacitors 21 and 22 form a differential capacitor pair; that is, when the capacitance of one of the sensing capacitors 21 and 22 increases, the capacitance of the other of the sensing capacitors 21 and 22 decreases. The arrangement of such differential capacitor pair can increase the sensitivity of the device. However, when a proof mass or a substrate of the prior art MEMS device 20 deforms, the differential capacitor pair cannot reduce the error caused by the deformation. For reference, U.S. Pat. Nos. 7,520,171, 7,646,582, and 2013/0186171 A1 disclose similar structures.

### SUMMARY OF THE INVENTION

In one perspective, the present invention provides a MEMS device with electrical compensation. The MEMS device includes a fixed structure, a movable structure, and a compensation circuit. The fixed structure includes at least one fixed electrode and at least one fixed compensation electrode. The movable structure includes at least one movable electrode and at least one movable compensation electrode. The at least one fixed electrode and the at least one movable electrode are located corresponding to each other to form at least one sensing capacitor, and the at least one fixed compensation electrode and the at least one movable compensation electrode are located corresponding to each other to form at least one compensation capacitor. The compensation circuit is coupled to the at least one sensing capacitor and the at least one compensation capacitor, for compensating a sensing signal generated by the at least one sensing capacitor with a compensation signal generated by the at least one compensation capacitor. The at least one sensing capacitor and the at least one compensation capacitor do not form a differential capacitor pair.

In one embodiment, a proportion of a sensing area of the at least one compensation capacitor to a sensing area of the at least one sensing capacitor is lower than 1.

In one embodiment, the movable structure further includes an axis, and the movable structure is driven to rotate or swing along the axis. The at least one movable compensation electrode and the at least one movable electrode are at a same side with respect to the axis.

In one embodiment, the movable structure further includes an axis, and the movable structure is driven to rotate or swing along the axis. A distance from the at least one movable compensation electrode to the axis, is equal to a distance from the at least one movable electrode to the axis.

In another embodiment, the movable structure further includes an axis, and the movable structure is driven to rotate or swing along the axis. A distance between the at least one movable compensation electrode and the axis, is larger than a distance between the at least one movable electrode and the axis.

In one embodiment, a projection of the at least one movable compensation electrode in an out-of-plane direction of the movable structure overlaps a projection of the at least one fixed compensation electrode in the out-of-plane direction of the movable structure to form the compensation capacitor; or a projection of the at least one movable compensation electrode in an in-plane direction of the movable structure overlaps a projection of the at least one fixed compensation electrode to form the compensation capacitor.

In one embodiment, the sensing signal generated by the sensing capacitor is compensated with the compensation signal generated by the compensation capacitor. The compensation signal (Cc) generated by the compensation capacitor is multiplied by a coefficient (K), and the product (K×Cc) is subtracted from the sensing signal (C) generated by the sensing capacitor to obtain a correlated sensing signal (C−K×Cc).

In one embodiment, a parameter (A/Ac) is defined as a quotient of a sensing area (A) of the at least one movable electrode divided by a sensing area (Ac) of the at least one movable compensation electrode, and the coefficient (K) is a function of the parameter (A/Ac).

In one embodiment, the movable structure further includes an axis, and the movable structure is driven to rotate or swing along the axis. A parameter (D/Dc) is defined as a quotient of a distance (D) between the axis and a centroid of a sensing area of the at least one movable electrode, divided by a distance (Dc) between the axis and a centroid of a sensing area of the at least one movable compensation electrode. The coefficient (K) is a function of the parameter (D/Dc).

In another perspective, the present invention provides a readout circuit of a MEMS device with electrical compensation. The MEMS device includes a fixed structure and a movable structure which is movable with respect to the fixed structure. The movable structure and the fixed structure form at least one sensing capacitor and at least one compensation capacitor. The at least one sensing capacitor generates a sensing signal (C) and the at least one at least one sensing capacitor generates a compensation signal (Cc). The readout circuit includes: a compensation circuit, for subtracting a product (K×Cc) of the compensation signal (Cc) multiplied by a coefficient (K) from the sensing signal (C), to obtain a correlated sensing signal (C−K×Cc) which is outputted as an output signal. The at least one sensing capacitor and the at least one compensation capacitor do not form a differential capacitor pair.

In one embodiment, a proportion of a sensing area of the at least one compensation capacitor to a sensing area of the at least one sensing capacitor is lower than 1.

In one embodiment, the compensation circuit includes a first simplifier, a second simplifier, and an adder. The first simplifier is coupled to the sensing capacitor, for processing the sensing signal (C) generated by the at least one sensing capacitor. The second simplifier is coupled to the compensation capacitor, for processing the compensation signal (Cc) generated by the at least one compensation capacitor. The adder is used to subtract an output of the second amplifier from an output of the first amplifier, to obtain the output signal. Preferably, at least one of the first amplifier and the second amplifier has an adjustable gain.

The objectives, technical details, features, and effects of the present invention will be better understood with regard to the detailed description of the embodiments below, with reference to the drawings.

### BRIEF DESCRIPTION OF THE DRAWINGS

FIGS. 1 and 2 show two MEMS devices according to prior art.

FIGS. 3-7 show MEMS devices with electrical compensation according to several embodiments of the present invention.

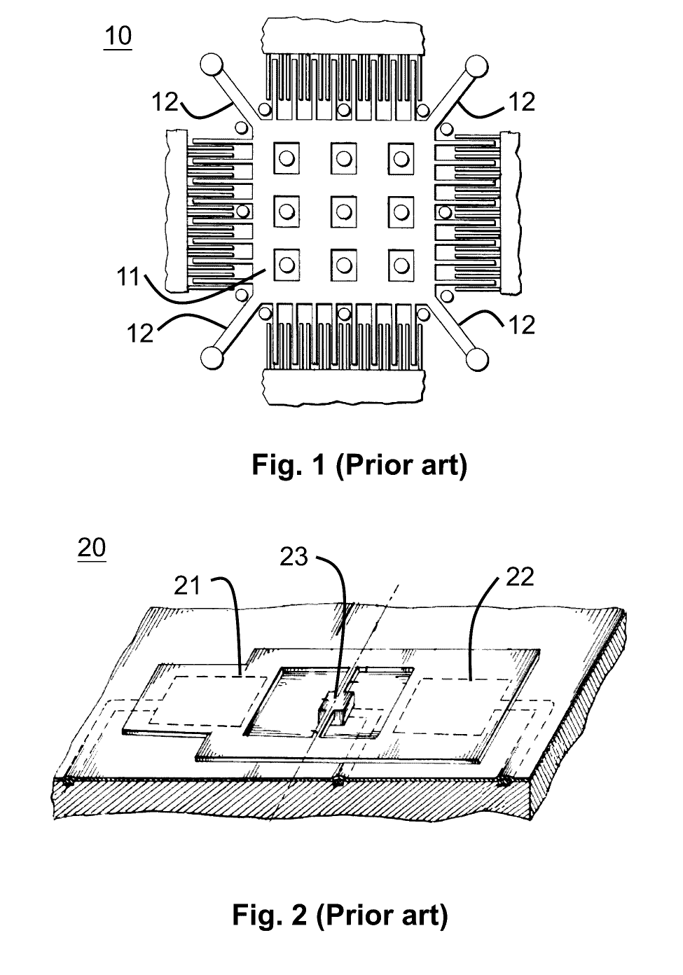

### DESCRIPTION OF THE PREFERRED EMBODIMENTS

The drawings as referred to throughout the description of the present invention are for illustrative purpose only, to show the interrelations between the circuits and/or devices, but not drawn according to actual scale. The orientation wordings in the description such as: above, under, left, or right are for reference with respect to the drawings, but not for limiting the actual product made according to the present invention.

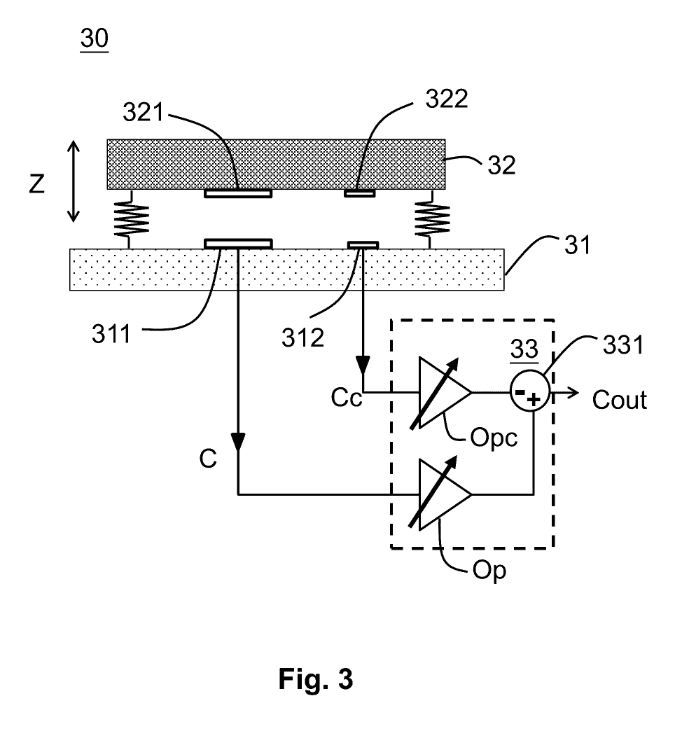

FIG. 3 shows a MEMS device 30 with electrical compensation according to one embodiment of the present invention. As shown in the figure, the MEMS device 30 with electrical compensation includes a fixed structure 31, a movable structure 32, and a compensation circuit 33. The fixed structure 31 for example can be but is not limited to a substrate, and the movable structure 32 for example can be but is not limited to a proof mass which can move relatively with respect to the fixed structure 31. The fixed structure 31 includes at least one fixed electrode 311 and at least one fixed compensation electrode 312. The movable structure 32 includes at least one movable electrode 321 and at least one movable compensation electrode 322. The at least one fixed electrode 311 and the at least one movable electrode 321 are located corresponding to each other to form at least one sensing capacitor. The at least one fixed compensation electrode 312 and the at least one movable compensation electrode 322 are located corresponding to each other to form at least one compensation capacitor. In FIG. 3, the numbers, shapes and arrangements of the fixed electrode 311, the fixed compensation electrode 312, the movable electrode 321, and the movable compensation electrode 322 are for illustrative purpose only and not for limiting the scope of the present invention. For example, that the electrodes are shown to protrude from the surface is simply for better illustration of their locations, while they do not need to actually protrude from the surface in a practical product; the number of each type of electrodes needs not be only one; the relative locations of the electrodes are not limited to the locations as shown in figure. The compensation circuit 33 receives a sensing signal C generated by the at least one sensing capacitor and a compensation signal Cc generated by the at least one compensation capacitor, and compensates the sensing signal C by the compensation signal Cc (to be explained in more detail later).

The sensing capacitor and the compensation capacitor do not form a differential capacitor pair with each other. In a preferred embodiment, the sensing area of the compensation capacitor is smaller than the sensing area of the sensing capacitor; a proportion of the sensing area of the compensation capacitor to the sensing area of the sensing capacitor is lower than 1 and preferably lower than ¼. In the embodiment shown in FIG. 3, the sensing area of the sensing capacitor is the overlapped area of a projection of the fixed electrode 311 and a projection of the movable electrode 321 in an out-of-plane direction of the substrate, and the sensing area of the compensation capacitor is the overlapped area of a projection of the fixed compensation electrode 312 and a projection of the movable compensation electrode 322 in an out-of-plane direction of the substrate. The proportion of the sensing area of the compensation capacitor to the sensing area of the sensing capacitor is lower than 1.

Still referring to FIG. 3, the compensation circuit 33 includes two amplifiers Op and Opc, which are respectively coupled to the sensing capacitor and the compensation capacitor, for respectively processing the sensing signal C generated by the at least one sensing capacitor and the compensation signal Cc generated by the at least one compensation capacitor. At least one of the amplifiers Op and Opc has an adjustable gain, or both of the amplifiers Op and Opc have adjustable gains. In one embodiment, the gain of the amplifier Op is 1 and the gain of the amplifier Opc is K (K is adjustable). The gain K can be adjusted for example as follows. First, the gain K can be set to an initial value such as 1 or any predetermined value when the MEMS device 30 is still, and the raw values of the sensing capacitor and the compensation capacitor are obtained. Next, the gain K is adjusted according to the deviation between the raw values and the desired values. Of course, the above is only one non-limiting example; the gain of the amplifier Op does not have to be 1, and the gain does not have to be a constant and can be adjustable. The gain of the amplifier Opc can be adjusted in correspondence with the setting of the gain of the amplifier Op. In one embodiment, the adder subtracts an output of the amplifier Opc from an output of the amplifier Op, to obtaining a compensated output signal Cout.

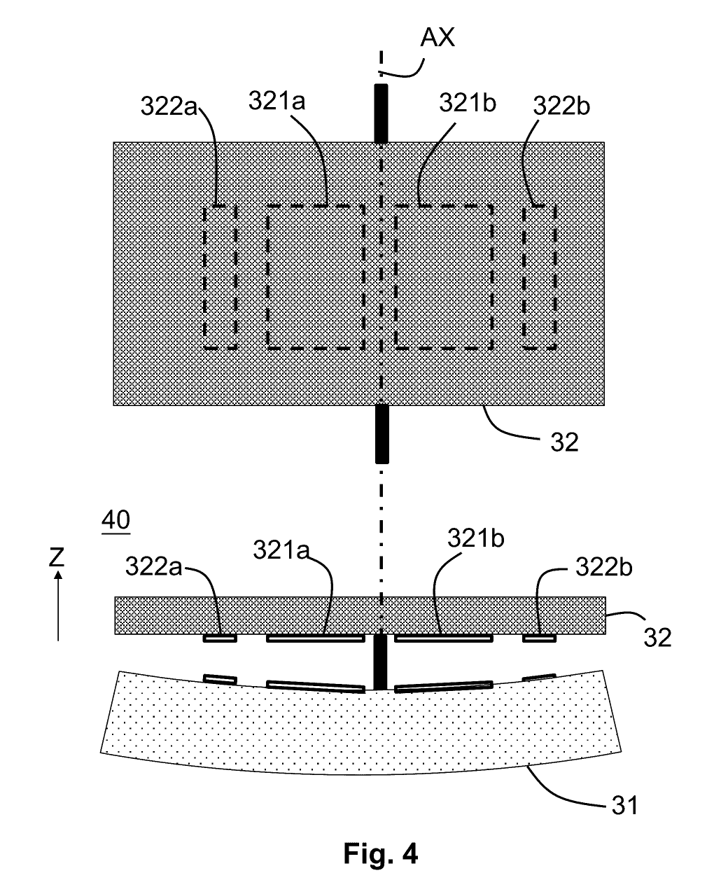

The sensing area and location of the movable compensation electrode 322 can be designed according to the limitation of manufacturing capability, and the requirements of stability and overall size. For example, for compensating substrate deformation, the movable compensation electrode 322 can be located at a position which can better sense the substrate deformation. As an example, if, according to a movement of the MEMS device 30, the movable structure 32 rotates or swings along an axis, then it can be designed so that a distance between the movable compensation electrode and the axis, is larger than a distance between the movable electrode and the axis (for example, the movable compensation electrodes 322a and 322b are farther from the axis AX than the movable electrodes 321a and 321b, referring to FIG. 4), such that the compensation capacitor senses a larger deformation to thereby have a better error signal rejection capability to the substrate deformation.

FIG. 4 shows a top view and a cross-section view of a MEMS device 40 according to another embodiment of the present invention, wherein the movable structure 32 includes an axis AX, two movable electrodes 321a and 321b, and two movable compensation electrodes 322a and 322b. The two movable electrodes 321a and 321b are respectively located at opposite sides of the axis AX, for forming a differential capacitor pair. The two movable compensation electrodes 322a and 322b are respectively located at opposite sides of the axis AX, for forming another differential capacitor pair. A first sensing capacitor is formed by the movable electrode 321a and the fixed electrode corresponding to the movable electrode 321a, and a second sensing capacitor is formed by the movable electrode 321b and the fixed electrode corresponding to the movable electrode 321b. When the movable structure 32 rotates around the axis AX to produce an out-of-plane rotation, the capacitances of the first and second sensing capacitors change in opposite directions, i.e., one increasing while the other decreasing. This embodiment explains that the present invention can include a differential capacitor pair. However, it should be noted that the sensing capacitor formed by the movable electrode 321a (and the corresponding fixed electrode, which is omitted in the following text for simplicity), does not form a differential capacitor pair with the compensation capacitor formed by the movable compensation electrode 322a or 322b. Similarly, the sensing capacitor formed by the movable electrode 321b, does not forma differential capacitor pair with the compensation capacitor formed by the movable compensation electrode 322a or 322b. Similar to the embodiment shown in FIG. 3, the compensation capacitor formed by the movable compensation electrode 322a can be used to compensate the output of the sensing capacitor formed by the movable electrode 321a, and the compensation capacitor formed by the movable compensation electrode 322b can be used to compensate the output of the sensing capacitor formed by the movable electrode 321b.

The sensed capacitances corresponding to the sensing capacitors and compensation capacitors formed by the movable electrodes 321a and 321b and the movable compensation electrodes 322a and 322b, are respectively represented by C321a, C321b, C322a, and C322b. Thus, the sensing signal C generated by the sensing capacitors can be (C321a−C321b), or can be (C321b−C321a). In this embodiment of the present invention, the sensing signal C is represented by (C321a−C321b) for illustrative purpose. The compensation signal Cc generated by the compensation capacitors can be (C322a−C322b) or (C322b−C322a), and in this embodiment of the present invention, the compensation signal Cc is represented by (C322a−C322b) for illustrative purpose. After compensation, the sensing result (a correlated sensing signal, which is the output signal Cout) can be represented by (C321a−C321b)−K×(C322a−C322b), wherein K is a coefficient, representing a ratio of again of the amplifier coupled to the compensation capacitor (s) to a gain of the amplifier coupled to the sensing capacitor(s) (referring to FIG. 3). This coefficient K can be designed according to the required compensation effect.

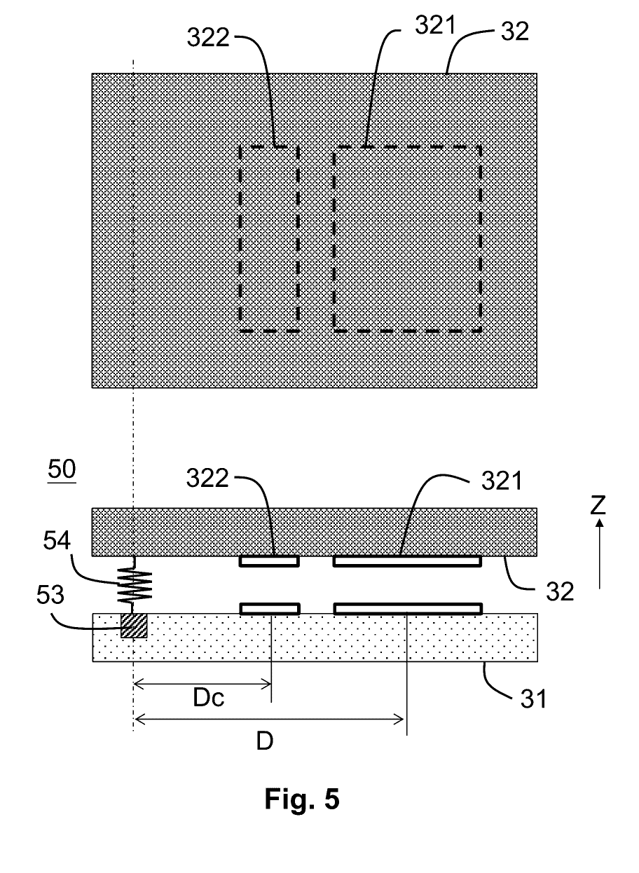

FIG. 5 shows a top view and a cross-section view of a MEMS device 50 according to yet another embodiment of the present invention. The MEMS device 50 includes a fixed structure 31 and a movable structure 32. The movable structure 32 includes a movable electrodes 321 and a movable compensation electrode 322. The movable structure 32 can swing in the out-of-plane direction Z, along an axis which is shown by a reference line in FIG. 5 that passes through an anchor 53 and a spring 54. In this embodiment, the aforementioned coefficient K can be correlated to a ratio of the sensing area of the sensing capacitor to the sensing area of the compensation capacitor. That is, assuming that the sensing area (A) of the at least one movable electrode 321 (which is equal to the sensing area of the sensing capacitor in this embodiment) is equal to an projection area of the movable electrode 321 overlapped by the corresponding fixed electrode in a top view of the substrate (in an out-of-plane direction of the movable structure), and the sensing area (Ac) of the at least one movable compensation electrode 322 (which is equal to the sensing area of the compensation capacitor in this embodiment) is equal to an projection area of the movable compensation electrode 322 overlapped by the corresponding fixed compensation electrode in a top view of the substrate (in an out-of-plane direction of the movable structure), then the coefficient K is correlated to a parameter (A/Ac). That is, the coefficient K can be a function of the parameter (A/Ac).

In another embodiment, referring to FIG. 5, a parameter (D/Dc) is defined by a quotient of a distance (D) between the axis and a centroid of a sensing area of the movable electrode, divided by a distance (Dc) between the axis and a centroid of a sensing area of the movable compensation electrode, and the coefficient K is correlated to the parameter (D/Dc). That is, the coefficient (K) is a function of the parameter (D/Dc).

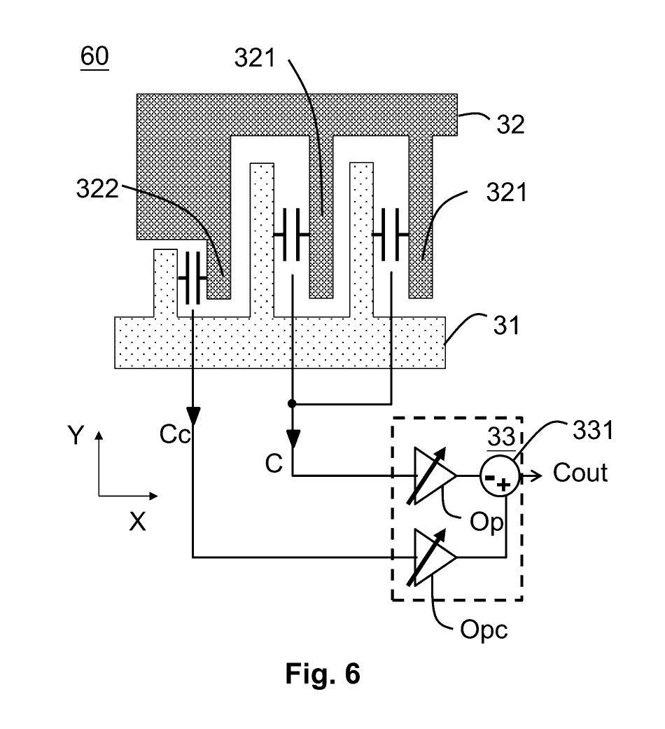

FIGS. 3 and 6 respectively show the MEMS devices of two different motion types according to the present invention. FIG. 3 shows the MEMS device 30 which is capable of sensing an out-of-plane movement (movement in the direction Z), and FIG. 6 shows a partial of the MEMS device 60 which is capable of sensing an in-plane movement (movement in the direction X or Y). In the embodiment of FIG. 6, the MEMS device 60 includes plural movable electrodes 321 and one movable compensation electrode 322, and FIG. 6 shows an example of the relative sizes of the movable electrodes 321 and the movable compensation electrode 322. The total sensing area of the sensing capacitors formed by the movable electrodes 321 and the corresponding fixed electrode is larger than the sensing area of the compensation capacitor formed by the movable compensation electrode 322 and the corresponding fixed compensation electrode. Referring to FIG. 6, the sensing areas of the sensing capacitors are the overlapped areas of the movable electrodes 321 and the corresponding fixed electrodes in a projection in the in-plane direction X in FIG. 6, and the sensing area of the compensation capacitor is the overlapped area of the movable compensation electrode 322 and the corresponding fixed compensation electrode in a projection in the in-plane direction X in FIG. 6. Similarly to the previous embodiments, the output of the compensation capacitor can be used to compensate the output of the sensing capacitor, and a proportion of the sensing area of the compensation capacitor to the sensing areas of the sensing capacitors is lower than 1, e.g., lower than ¼. This embodiment shows that the present invention can be applied not only to a MEMS device sensing an out-of-plane movement but also to a MEMS device sensing an in-plane movement. That is, the MEMS device of the present invention can be a one-dimensional or a multi-dimensional sensor.

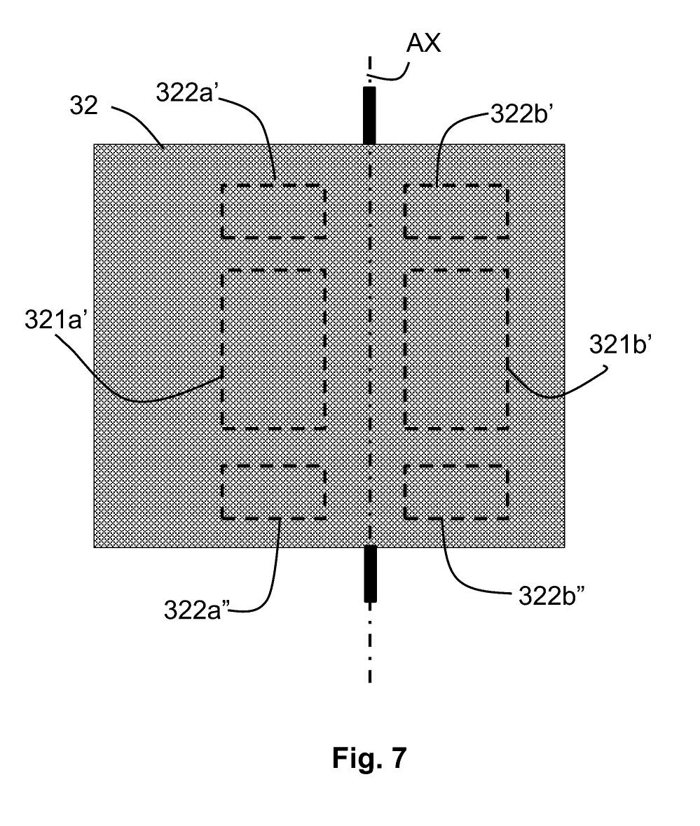

FIGS. 4 and 7 respectively show two arrangements of the movable compensation electrodes according to the present invention. In the embodiment of FIG. 4, with respect to the axis AX, the movable compensation electrode 322a is located outside the movable electrode 321a, and the movable compensation electrode 322b is also located outside the movable electrode 321b. However, the arrangement of movable electrodes and the movable compensation electrodes is not limited to the example shown in FIG. 4. According to the present invention, in the embodiment shown in FIG. 7, a distance between the axis AX and the movable compensation electrode 322a′ (and the movable compensation electrode 322a″), is equal to a distance between the axis AX and the movable electrode 321a′. That is, the movable compensation electrode 322a′, 322a″, and the movable electrode 321a′ are located in parallel to the axis AX. Similarly, a distance between the axis AX and the movable compensation electrode 322b′ (or the movable compensation electrode 321b″), is equal to a distance between the axis AX and the movable electrode 321a′. That is, the movable compensation electrode 322a′, 322a″, and the movable electrode 321a′ are located in parallel to the axis AX.

The sensed capacitances corresponding to the sensing capacitors formed respectively by the movable electrodes 321a′ and 321b′, and the sensed capacitances corresponding to the compensation capacitors formed respectively by the movable compensation electrodes 322a′, 322a″, 322b′ and 322b″, are represented by C321a′, C321b′, C322a′, C322a″, C322b′, and C322b″, respectively. The total sensing signal C of the MEMS device of FIG. 7 can be either (C321a′−C321b′) or (C321b′−C321a′), and let us use (C321a′−C321b′) for illustrative purpose. The total compensation signal Cc can be either (C322a′+C322a″−C322b′−C322b″) or (C322b′+C322b″−C322a′−C322a″), and let us use (C322a′+C322a″−C322b′−C322b″) for illustrative purpose. After compensation, the sensing result (a correlated sensing signal, which is the output signal Cout) of the MEMS device of FIG. 7 can be (C321a′-C321b′)−K×(C322a′+C322a″−C322b′−C322b″). The coefficient K represents a ratio of a gain of the amplifier coupled to the compensation capacitor(s) to a gain of the amplifier coupled to the sensing capacitor (referring to FIG. 3), and this coefficient K can be designed according to according to the required compensation effect. This embodiment illustrates that the movable compensation electrode can be located outside of or in parallel to the movable electrode, with respect the axis AX.

In another perspective, the present invention provides a readout circuit of MEMS device with electrical compensation. The MEMS device includes a fixed structure and a movable structure which is movable with respect to the fixed structure. The movable structure and the fixed structure form at least one sensing capacitor and at least one compensation capacitor. The at least one sensing capacitor generates a sensing signal (C) and the at least one at least one sensing capacitor generates a compensation signal (Cc). The readout circuit includes: a compensation circuit, subtracting a product (K×Cc) of the compensation signal (Cc) multiplied by a coefficient (K) from the sensing signal (C), to obtain a correlated sensing signal (C−K×Cc) which is outputted as an output signal. The at least one sensing capacitor and the at least one compensation capacitor do not form a differential capacitor pair. Preferably, a proportion of the sensing area of the compensation capacitor to the sensing area of the sensing capacitor is lower than 1; for example, the proportion can be lower than ¼. The movable electrode and the fixed electrode corresponding to the movable electrode can form a sensing capacitor for sensing an out-of-plane movement or an in-plane movement.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. Besides, a device or a circuit which does not affect the primary function of the units can be inserted between two units shown to be in direct connection in the figures of the present invention. An embodiment or a claim of the present invention does not need to attain or include all the objectives, advantages or features described in the above. The abstract and the title are provided for assisting searches and not to be read as limitations to the scope of the present invention.

What is claimed is:

1. A micro-electro-mechanical system (MEMS) device with electrical compensation, comprising:
a fixed structure, including at least one fixed electrode and at least one fixed compensation electrode;
a movable structure, including at least one movable electrode and at least one movable compensation electrode, wherein the at least one fixed electrode and the at least one movable electrode are located corresponding to each other to format least one sensing capacitor, and wherein the at least one fixed compensation electrode and the at least one movable compensation electrode are located corresponding to each other to form at least one compensation capacitor; and
a compensation circuit, coupled to the at least one sensing capacitor and the at least one compensation capacitor, for compensating a sensing signal generated by the at least one sensing capacitor with a compensation signal generated by the at least one compensation capacitor;
wherein the at least one sensing capacitor and the at least one compensation capacitor do not form a differential capacitor pair.

2. The MEMS device with electrical compensation of claim 1, wherein a proportion of a sensing area of the at least one compensation capacitor to a sensing area of the at least one sensing capacitor is lower than 1.

3. The MEMS device with electrical compensation of claim 1, wherein the movable structure further includes an axis, and the movable structure is driven to rotate or swing along the axis, wherein the at least one movable compensation electrode and the at least one movable electrode are at a same side with respect to the axis.

4. The MEMS device with electrical compensation of claim 1, wherein the movable structure further includes an axis, and the movable structure is driven to rotate or swing along the axis, wherein a distance between the at least one movable compensation electrode and the axis is equal to a distance between the at least one movable electrode and the axis.

5. The MEMS device with electrical compensation of claim 1, wherein the movable structure further includes an axis, and the movable structure is driven to rotate or swing along the axis, wherein a distance between the at least one movable compensation electrode and the axis is larger than a distance between the at least one movable electrode and the axis.

6. The MEMS device with electrical compensation of claim 1, wherein a projection of the at least one movable compensation electrode in an out-of-plane direction of the movable structure overlaps a projection of the at least one fixed compensation electrode in the out-of-plane direction of the movable structure to form the compensation capacitor; or a projection of the at least one movable compensation electrode in an in-plane direction of the movable structure overlaps a projection of the at least one fixed compensation electrode to form the compensation capacitor.

7. The MEMS device with electrical compensation of claim 1, wherein the sensing signal generated by the sensing capacitor is compensated with the compensation signal generated by the compensation capacitor by:
multiplying the compensation signal (Cc) generated by the compensation capacitor by a coefficient (K) to generate a product (K×Cc); and
subtracting the product (K×Cc) from the sensing signal (C) generated by the sensing capacitor to obtain a correlated sensing signal (C−K×Cc).

8. The MEMS device with electrical compensation of claim 7, wherein a parameter (A/Ac) is defined as a quotient of a sensing area (A) of the at least one movable electrode divided by a sensing area (Ac) of the at least one movable compensation electrode, and the coefficient (K) is a function of the parameter (A/Ac).

9. The MEMS device with electrical compensation of claim 7, wherein the movable structure further includes an axis, and the movable structure is driven to rotate or swing along the axis, wherein a parameter (D/Dc) is defined as a quotient of a distance (D) between the axis and a centroid of a sensing area of the at least one movable electrode divided by a distance (Dc) between the axis and a centroid of a sensing area of the at least one movable compensation, and the coefficient (K) is a function of the parameter (D/Dc).

10. A readout circuit of a micro-electro-mechanical system (MEMS) device with electrical compensation, the MEMS device including a fixed structure and a movable structure which is movable with respect to the fixed structure, the movable structure and the fixed structure forming at least one sensing capacitor and at least one compensation capacitor, wherein the at least one sensing capacitor generates a sensing signal (C) and the at least one at least one sensing capacitor generates a compensation signal (Cc), the readout circuit comprising:
a compensation circuit, subtracting a product (K×Cc) of the compensation signal (Cc) multiplied by a coefficient (K) from the sensing signal (C), to obtain a correlated sensing signal (C−K×Cc) which is outputted as an output signal;
wherein the at least one sensing capacitor and the at least one compensation capacitor do not form a differential capacitor pair.

11. The readout circuit of MEMS device with electrical compensation of claim 10, wherein a proportion of a sensing area of the at least one compensation capacitor to a sensing area of the at least one sensing capacitor is lower than 1.

12. The readout circuit of MEMS device with electrical compensation of claim 10, wherein the compensation circuit comprising:
a first amplifier, coupled to the sensing capacitor, for processing the sensing signal (C) generated by the at least one sensing capacitor;
a second amplifier, coupled to the compensation capacitor, for processing the compensation signal (Cc) generated by the at least one compensation capacitor; and
an adder, subtracting an output of the second amplifier from an output of the first amplifier, for obtaining the output signal;
wherein at least one of the first amplifier and the second amplifier has an adjustable gain.
